(19) United States
(12) Patent Application Publication
(10) Pub. No.: US 2013/0049607 A1
(43) Pub. Date: Feb. 28, 2013

(54) CONTROLLER, METHOD OF CONTROLLING ILLUMINATION, AND NETWORK SYSTEM

(71) Applicant: Shigeru Urata, Osaka-shi (JP)

(72) Inventor: Shigeru Urata, Osaka-shi (JP)

(73) Assignee: SHARP KABUSHIKI KAISHA, Osaka-shi, Osaka (JP)

(21) Appl. No.: 13/696,471

(22) PCT Filed: Mar. 9, 2011
(86) PCT No.: PCT/JP2011/055459

§ 371 Date: Nov. 6, 2012

(30) Foreign Application Priority Data
May 21, 2010 (JP) 2010-117223

(51) Int. Cl. H05B 37/02

(52) U.S. Cl. 315/153; 315/297

(57) ABSTRACT

A controller includes a communication interface for communicating with at least one illumination and a plurality of home appliances; a memory for storing a corresponding relationship between the plurality of home appliances and a lighting up scheme of the illumination; and a processor for obtaining, upon receiving a signal from one of the plurality of home appliances indicating the state thereof, a lighting up scheme corresponding to the home appliance on the basis of the corresponding relationship, using the communication interface, and for instructing at least one illumination to light up in accordance with the lighting up scheme.

### TECHNICAL FIELD

The present invention relates to the technique of a controller for controlling devices installed in a residence or the like. Particularly, the present invention relates to a controller that can be connected to home appliances and illumination in a residence, a method of controlling the illumination, and a network system.

### BACKGROUND ART

A controller provided at a residence or the like for controlling devices that are located in the residence is proposed. For example, there is proposed the technique for a controller to control home appliances such as a washing machine, microwave oven, refrigerator, air conditioner, television, and solar cell, and/or display the state of such home appliances.

Japanese Patent Laying-Open No. 11-146991 (PTL 1) discloses a washing machine. According to Japanese Patent Laying-Open No. 11-146991 (PTL 1), the washing machine includes a display unit and communication means (an antenna or the like) for transmitting and receiving data to constitute a network via the communication means with other home appliances similarly incorporating the communication means and display unit such as an air conditioner, television, refrigerator, personal computer, and the like. Another home appliance connected on the network by the communication means is notified of the laundry progressing state and/or occurrence of an error at the washing machine to inform the progressing state and/or error about the washing machine through another home appliance.

Japanese Patent Laying-Open No. 2002-45590 (PTL 2) discloses a washing machine. According to Japanese Patent Laying-Open No. 2002-45590 (PTL 2), the washing machine is provided with a transmission device for transmitting the progressing contents of the operation of the washing machine, and includes a portable radio reception device receiving information from the transmission device. The portable radio reception device is provided with a confirmation button for confirming the progressing contents of the operation, and any notification of information requiring emergency is immediately and automatically provided to the portable radio reception device through audio or display.

Japanese Patent Laying-Open No. 2003-162626 (PTL 3) discloses an information notification system and equipment. According to Japanese Patent Laying-Open No. 2003-162626 (PTL 3), a control unit of a microwave oven transmits, when a determination is made that a state where the user should be notified occurs at the microwave oven, the state information indicating the relevant state to a refrigerator by means of a communication unit. The control unit of the refrigerator stores, when the state information is received through the communication unit, that state information in a storage unit, and displays the state information at the display unit in response to an operation being made at an operation unit, based on a determination that the user is present in the proximity of the refrigerator.

### CITATION LIST

### Patent Literature

PTL 1: Japanese Patent Laying-Open No. 11-146991
PTL 2: Japanese Patent Laying-Open No. 2002-45590
PTL 3: Japanese Patent Laying-Open No. 2003-162626

### SUMMARY OF INVENTION

### Technical Problem

However, there is a possibility that the state of a home appliance installed in the residence is not properly conveyed to the user at the residence. For example, in the case where the user is not in the proximity of the home appliance, or when the ambient sound is great, the possibility of the user not becoming aware of the notification from the home appliance or portable device is high.

In view of the foregoing, an object of the present invention is to provide a controller that can convey the state of a home appliance installed in a residence more effectively to the user of the relevant home appliance, a method of controlling illumination, and a network system.

### Solution to Problem

According to an aspect of the present invention, there is provided a controller including a communication interface for communication with at least one illumination and a plurality of home appliances; a memory for storing a corresponding relationship between the plurality of home appliances and a lighting up scheme of the illumination; and a processor for obtaining, upon receiving a signal from one of the plurality of home appliances indicating the state thereof, a lighting up scheme corresponding to the home appliance on the basis of the corresponding relationship, using the communication interface, and for instructing at least one illumination to light up in accordance with the lighting up scheme.

Preferably, the illumination can emit light of a plurality of colors. The memory stores the plurality of colors corresponding to the plurality of home appliances, respectively, as the lighting up scheme. The processor obtains, upon receiving a signal from one of the plurality of home appliances, a color corresponding to the home appliance, as the lighting up scheme, using the communication interface, and instructs at least one of the illumination to emit light of the color.

Preferably, the memory stores the corresponding relationship between a state of a home appliance and a blinking rhythm of illumination. The signal indicates the state of the home appliance. The processor obtains, upon receiving the signal, a blinking rhythm corresponding to the state on the basis of the corresponding relationship, using the communication interface, and instructs at least one of the illumination to emit light in accordance with the blinking rhythm.

Preferably, the communication interface establishes communication with a motion sensor installed in a room where illumination is installed. The memory stores the corresponding relationship between the motion sensor and illumination. The processor instructs the illumination installed in a room where a person is present to emit light on the basis of the signal received from the motion sensor, using the communication interface.

Preferably, the communication interface establishes communication with a brightness sensor installed in the room where the illumination is installed. The processor instructs emission of light at an intensity corresponding to lightness in the room on the basis of the signal from the brightness sensor, using the communication interface.

Preferably, the memory stores, for each home appliance, a state corresponding to a priority level. The processor obtains, when the processor receives a plurality of the states using the communication interface, the blinking rhythm corresponding to the state having a higher priority level, and instructs at least one of the illumination to emit light in accordance with the blinking rhythm.

Preferably, the illumination includes an LED (Light Emitting Diode).

According to another aspect of the present invention, there is provided a method for controlling illumination by a controller including a communication interface for communication with at least one illumination that can emit light of a plurality of colors and a plurality of home appliances, a memory for storing a corresponding relationship between the plurality of home appliances and a lighting up scheme of the illumination, and a processor. The method for controlling includes the steps of: receiving, by the processor, a signal indicating a state of the home appliance from any of the plurality of home appliances, using the communication interface; obtaining, by the processor, a lighting up scheme corresponding to the home appliance on the basis of the corresponding relationship, referring to the memory; and instructing, by the processor, at least one of the illumination to light up in accordance with the relevant lighting up scheme, using the communication interface.

According to a further aspect of the present invention, there is provided a network system including at least one illumination that can emit light of a plurality of colors, a plurality of home appliances, and a controller. Each of the plurality of home appliances transmits a signal indicating a state of the relevant home appliance to the controller. The controller includes a communication interface for communicating with at least one illumination and a plurality of home appliances, a memory for storing a corresponding relationship between the plurality of home appliances and a lighting up scheme of the illumination, and a processor for obtaining, upon receiving a signal from one of the plurality of home appliances indicating the state thereof, a lighting up scheme corresponding to the home appliance on the basis of the corresponding relationship, using the communication interface, and for instructing to at least one illumination to light up in accordance with the lighting up scheme. At least one illumination emits light according to an instruction from the controller.

### Advantageous Effects of Invention

According to the present invention, there is provided a controller that can convey the state of a home appliance installed in a residence to the user of the relevant home appliance more efficiently, a method of controlling illumination, and a network system.

### BRIEF DESCRIPTION OF DRAWINGS

FIG. 1 shows a pictorial representation of an entire configuration of a network system according to an embodiment.

FIG. 2 shows a pictorial representation of a lighting up operation of any of LEDs when the state of a washing machine has changed according to the present embodiment.

FIG. 3 shows a pictorial representation of a lighting up operation of any of LEDs when the state of a washing machine and refrigerator has changed according to the present embodiment.

FIG. 4 is a block diagram representing a hardware configuration of a home controller according to the present embodiment.

FIG. 5 shows a pictorial representation of a data structure of a motion sensor table according to the present embodiment.

FIG. 6 shows a pictorial representation of a data structure of an illumination table according to the present embodiment.

FIG. 7 shows a pictorial representation of a data structure of a lighting up scheme table according to the present embodiment.

FIG. 8 shows a pictorial representation of a data structure of an exemplary modification of a lighting up scheme table according to the present embodiment.

FIG. 9 shows a pictorial representation of a data structure of a home appliance table according to the present embodiment.

FIG. 10 shows a pictorial representation of a data structure of control data transmitted to an LED by the home controller according to the present embodiment.

FIG. 11 shows a pictorial representation of an entire operation of a network system according to the present embodiment.

FIG. 12 is a flowchart of the processing procedure of an illumination control method by the home controller according to the present embodiment.

FIG. 13 is a flowchart of the procedure of washing machine processing at the home controller according to the present embodiment.

FIG. 14 is a flowchart of the procedure of refrigerator processing at the home controller according to the present embodiment.

FIG. 15 is a flowchart of the procedure of microwave oven processing at the home controller according to the present embodiment.

### DESCRIPTION OF EMBODIMENTS

Embodiments of the present invention will be described hereinafter with reference to the drawings. In the following description, the same elements have the same reference characters allotted. Their designation and function are also identical.

Therefore, detailed description thereof will not be repeated.

<Operation Overview of Network System>

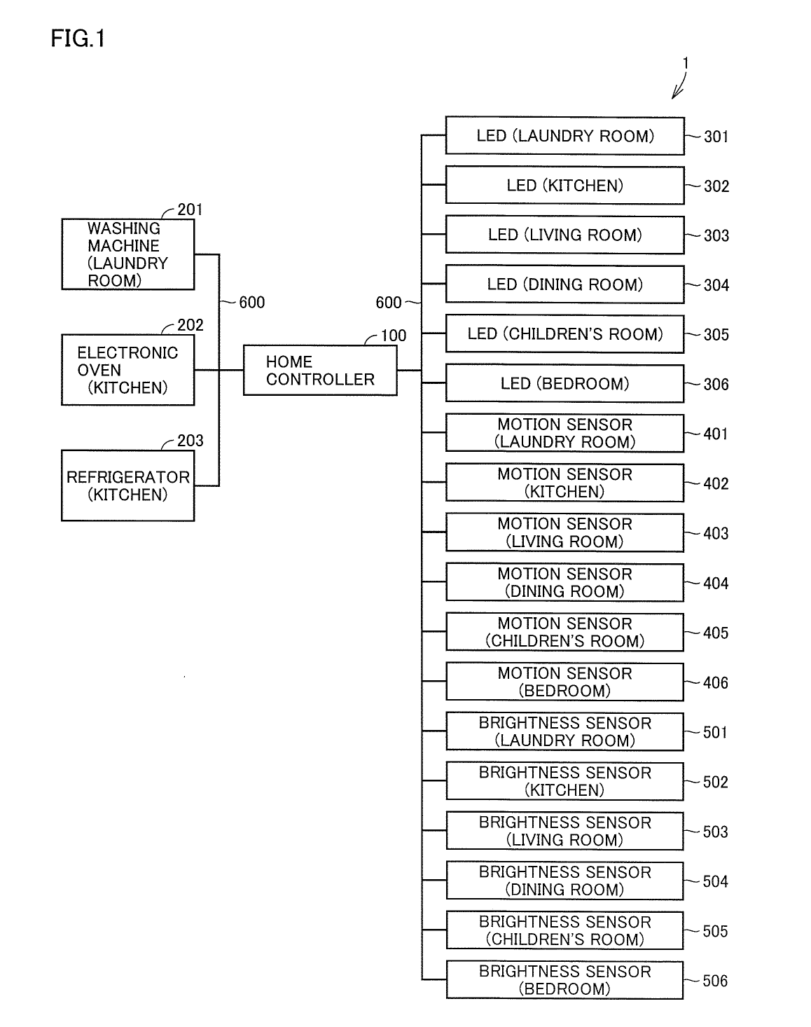

First, an operation overview of a network system according to the present embodiment will be described. FIG. 1 shows a pictorial representation of the entire configuration of a network system 1 according to the present embodiment.

Referring to FIG. 1, network system 1 of the present embodiment is installed in, for example, a residence, an office, or the like. Network system 1 includes a plurality of home appliances such as a washing machine 201 installed in a laundry room, a microwave oven 202 installed in a kitchen, and a refrigerator 203 installed in the kitchen. Network system 1 may also include an air conditioner, a television, and a solar cell as the home appliance.

Network system 1 includes a plurality of illuminations such as an LED (Light Emitting Diode) 301 installed in the laundry room, an LED 302 installed in the kitchen, an LED 303 installed in a living room, an LED 304 installed in a dining room, an LED 305 installed in a children's room, and an LED 306 installed in a bedroom.

LEDs 301-306 preferably emit light of a plurality of colors according to an externally applied instruction. Accordingly, the types of the lighting up scheme of LEDs 301-306 can be increased to allow more information of home appliances and status thereof to be conveyed to the user.

Preferably, LEDs 301-306 can modify the blinking interval (blinking rhythm) of light according to an externally applied instruction. Accordingly, the types of the lighting up scheme of LEDs 301-306 can be increased to allow more information of home appliances and status thereof to be conveyed to the user.

Further, LEDs 301-306 preferably modifies the light intensity (luminance) according to an externally applied instruction. Accordingly, the types of the lighting up scheme of LEDs 301-306 can be increased to allow more information of home appliances and status thereof to be conveyed to the user.

Although network system 1 includes LEDs 301-306 in the present embodiment, other illumination may be used. However, it is preferable to use illumination that is less unlikely to have the service lifetime shortened by ON/OFF switching. Further preferably, the illumination can emit light of a plurality of colors. Furthermore, illumination that can readily modify its intensity is preferably used.

Network system 1 further includes a motion sensor 401 installed in the laundry room, a motion sensor 402 installed in the kitchen, a motion sensor 403 installed in the living room, a motion sensor 404 installed in the dining room, a motion sensor 405 installed in the children's bedroom, and a motion sensor 406 installed in the bedroom.

Network system 1 further includes a brightness sensor 501 installed in the laundry room, a brightness sensor 502 installed in the kitchen, a brightness sensor 503 installed in the living room, a brightness sensor 504 installed in the dining room, a brightness sensor 505 installed in the children's room, and a brightness sensor 506 installed in the bedroom.

Network system 1 includes a home controller 100 for controlling home appliances 201-203, illuminations 301-306, motion sensors 401-406, and brightness sensors 501-506. In other words, home controller 100 can establish data communication with home appliances 201-203, illuminations 301-306, motion sensors 401-406, and brightness sensors 501-506 via a wired or wireless network 600. Home controller 100 employs, as network 600, a wired LAN (Local Area Network), a wireless LAN, a PLC (Power Line Communications), Bluetooth (registered trademark), or the like.

Home controller 100 according to the present embodiment receives a signal from a plurality of home appliances 201-203 installed in the residence via network 600. Home controller 100 obtains a state of home appliances 201-203 based on a relevant signal. Home controller 100 determines a lighting up scheme of illumination according to information (signal) to identify any of home appliances 201-203. Home controller 100 transmits a lighting up instruction (blinking instruction) to LEDs 301-306 via network 600.

More specifically, home controller 100 determines the illumination lighting up scheme according to information (signal) identifying any of home appliances 201-203, and information (signal) identifying any state of relevant home appliances 201-203. Home controller 100 transmits to LEDs 301-306 a lighting up instruction (blinking instruction) via network 600. For example, home controller 100 can store each of home appliances 201-203 associated with a color, and each state associated with a blinking rhythm (blinking interval or the like of each color).

Home controller 100 transmits a lighting up instruction to LEDs 301-306 installed in a room where a person is present based on the signals from motion sensors 401-406. Home controller 100 does not have to transmit a lighting up instruction to any of LEDs 301-306 when the user is present in a room where home appliances 201-203 of interest are installed. This is because the possibility of the user to identify the state of home appliances 201-203 of interest is high.

Further, home controller 100 instructs each of LEDs 301-306 to light up at a level according to the lightness of the relevant room, based on a signal from brightness sensors 501-506 located at the room where a relevant one of LEDs 301-306 is installed.

For example, home controller 100 instructs LEDs 301-306 located at a light room to light up at high intensity to promote the user to become aware of the light emitted from LEDs 301-306. This is because the user will be less likely to become aware of the light from LEDs 301-306 during the day time or in a light room.

In contrast, home controller 100 instructs LEDs 301-306 located at a dark room to light up at a lower intensity. This is because the user is more likely to become aware of the light from LEDs 301-306 during the night time or while in bed. Another reason is that the user may be bothered by the light from LEDs 301-306 while in bed.

Moreover, home controller 100 may transmit a lighting up instruction to all LEDs 301-306, or to only a predetermined LED 301 (or, LED 302, 303, 304, 305, 306).

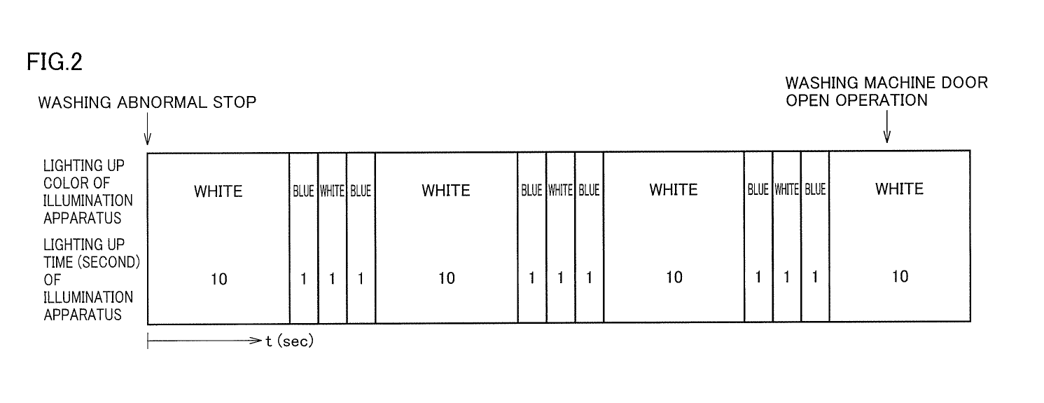

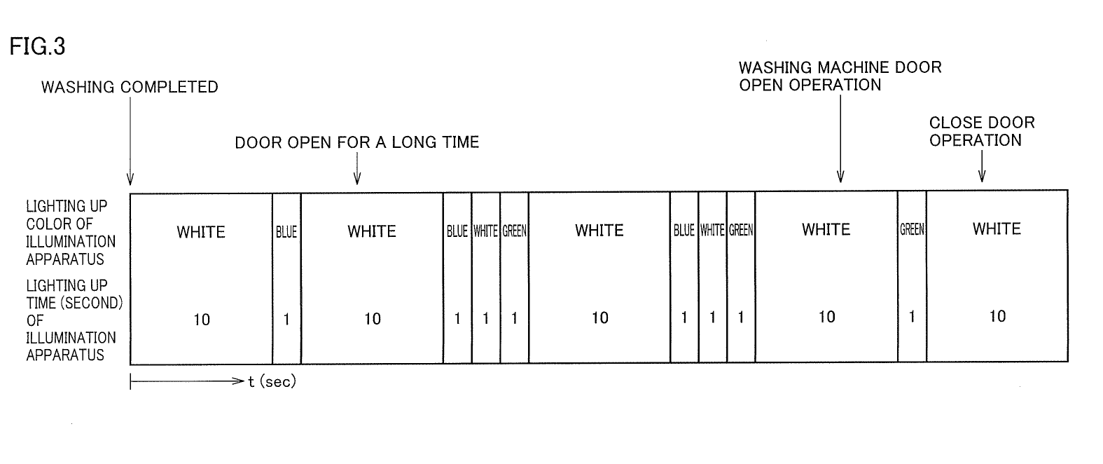

FIG. 2 shows a pictorial representation of a lighting up operation of any of LEDS 301-306 when the state of washing machine 201 has changed according to the present embodiment. FIG. 3 shows a pictorial representation of the lighting up operation of any of LEDs 301-306 when the state of washing machine 201 and refrigerator 203 according to the present embodiment has changed. It is assumed that home controller 100 of the present embodiment stores the information of washing machine 201 associated with the color of blue, and refrigerator 203 associated with the color of green.

Referring to FIG. 2, when a first state occurs at washing machine 201 (an error occurring at washing machine 201), home controller 100 receives a first state message from washing machine 201. Home controller 100 sends a first blue color blinking instruction to LED 301 located at a room where a person is present. LED 301 responds to the first blue color blinking instruction from home controller 100 to emit light of white and blue according to a series of first blue color blinking rhythm constituted of white for 10 seconds, blue for 1 second, white for 1 second, and blue for 1 second. Accordingly, the user can identify that the first state has occurred at washing machine 201.

Then, when the first state of washing machine 201 is canceled (the lid of washing machine 201 is open), home controller 100 receives a normal state message from washing machine 201. Home controller 100 sends, for example, a white color lighting up instruction to LED 301 located at the room where a person is present. LED 301 responds to the lighting up instruction from home controller 100 to emit light of white color.

Referring to FIG. 3, when a second state occurs at washing machine 201 (the cleaning operation ends), home controller 100 receives a second state message from washing machine 201. Home controller 100 sends a second blue color blinking instruction to LED 301 located at the room where a person is present. LED 301 responds to the second blue color blinking instruction from home controller 100 to emit light of white and blue according to a series of second blue color blinking rhythm constituted of white for 10 seconds and blue for 1 second. Accordingly, the user can identify that the second state has occurred at washing machine 201.

Then, when a first state occurs at refrigerator 203 (the door is open for more than a predetermined time), home controller 100 receives a first state message from refrigerator 203. Home controller 100 sends, for example, a blue-green color blinking instruction to LED 301 located at the room where a person is present. LED 301 responds to the blue-green color blinking instruction from home controller 100 to emit light of white, blue, and green based on a series of blue-green color blinking rhythm constituted of white for 10 seconds, blue for 1 second, white for 1 second and blue for 1 second. Accordingly, the user can identify that the state at the washing machine and refrigerator has changed.

Then, when the second state of washing machine 201 is canceled, home controller 100 receives a normal state message from washing machine 201. Home controller 100 transmits, for example, a first green color blinking instruction to LED 301 located at the room where a person is present. LED 301 responds to the first green color blinking instruction from home controller 100 to emit light of white and green based on a series of first green color blinking rhythm constituted of white for 10 seconds, and green for 1 second. Then, when the first state of refrigerator 203 is canceled, home controller 100 receives a normal state message from refrigerator 203. Home controller 100 sends, for example, a white color lighting up instruction to LED 301 located at the room where a person is present. LED 301 responds to the white color lighting up instruction from home controller 100 to emit white light.

Thus, since LEDs 301-306 emit light by a lighting up scheme corresponding to the home appliance and state thereof in network system 1 of the present embodiment, the state of a home appliance installed in the residence can be conveyed more effectively to the user of the relevant home appliance. More specifically, the user can readily identify a home appliance and a specific state thereof by visually utilizing three dimensional information of the color, blinking rhythm, and intensity of LEDs 301-306.

This technique is particularly effective when the sound around the user is great or for a user who is hearing impaired. In other words, the relevant home appliance and state of the home appliance can be identified even if the user is not in the proximity of home controller 100 or home appliances 201-203, or is present in a room different from the room where home controller 100 and/or home appliances 201-203 are located.

A specific configuration of network system 1 to implement such functions will be described in detail hereinafter.

<Hardware Configuration of Home Controller 100>

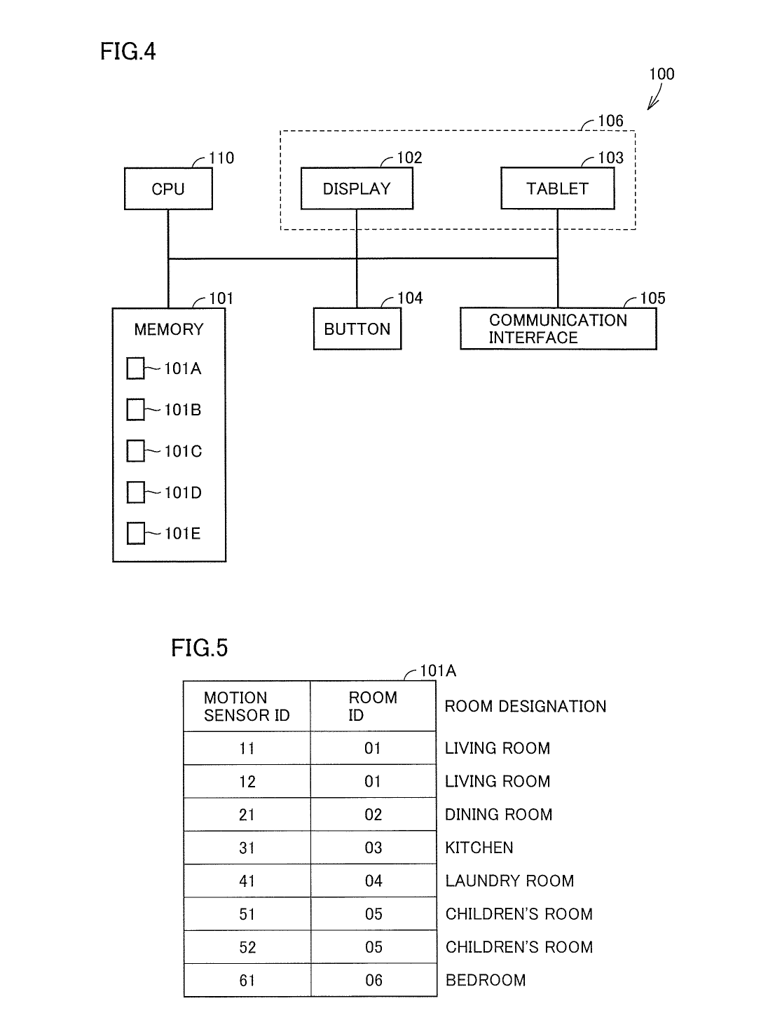

An aspect of a hardware configuration of home controller 100 according to the present embodiment will be described hereinafter. FIG. 4 is a block diagram of a hardware configuration of home controller 100 according to the present embodiment.

Home controller 100 includes a memory 101, a display 102, a tablet 103, a button 104, a communication interface 105, and a CPU (Central Processing Unit) 110.

Memory 101 includes various RAMs (Random Access Memory), ROM (Read-Only Memory), hard disk, or the like. Memory 101 stores an illumination control program executed by CPU 110, the state of home appliances 201-203, and the like. Memory 101 stores a motion sensor table 101A, an illumination table 101B, a lighting up scheme table 101C, a home appliance table 101D, and a brightness sensor table 101E.

FIG. 5 shows a pictorial representation of a data structure of motion sensor table 101A according to the present embodiment. Referring to FIG. 5, the motion sensor table stores the corresponding relationship between a sensor ID for identifying motion sensors 401-406, and a room ID identifying the room where a relevant one of motion sensors 401-406 is installed.

The data structure of brightness sensor table 101E is similar to the data structure of motion sensor table 101A. Therefore, description thereof will not be repeated.

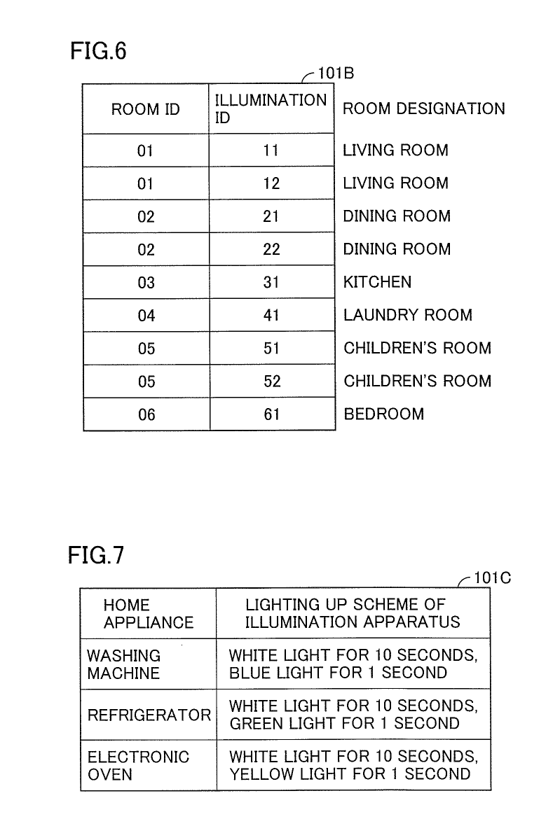

FIG. 6 shows a pictorial representation of a data structure of illumination table 101B according to the present embodiment. Referring to FIG. 6, illumination table 101 B stores the corresponding relationship between an illumination ID for identifying illuminations 301-306 and a room ID identifying the room where a relevant one of illuminations 301-306 is installed.

FIG. 7 shows a pictorial representation of a data structure of lighting up scheme table 101C according to the present embodiment. Referring to FIG. 7, lighting up scheme table 101C stores the corresponding relationship between a home appliance and a lighting up scheme. In the present embodiment, lighting up scheme table 101C stores the corresponding relationship between a home appliance and a color of light. For example, washing machine 201 is associated with the blue color, refrigerator 203 is associated with the green color, and microwave oven 202 is associated with the yellow color.

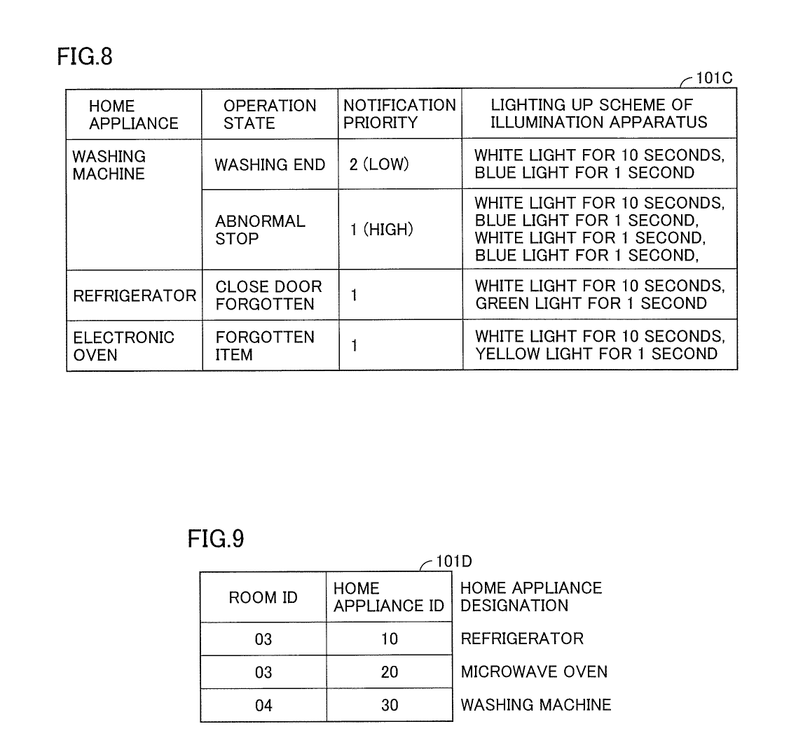

FIG. 8 shows a pictorial representation of a data structure of an exemplary modification of lighting up scheme table 101C according to the present embodiment. Referring to FIG. 8, lighting up scheme table 101C stores the corresponding relationship between a home appliance, a home appliance state, a notification priority level, and a lighting up scheme. In the present modification, the lighting up scheme table 101C stores, not only the corresponding relationship between a home appliance and color of light, but also the corresponding relationship between a home appliance state and a blinking rhythm.

For example, lighting up scheme table 101C stores the corresponding relationship between a home appliance and the color of light. For example, washing machine 201 is associated with the blue color, refrigerator 203 is associated with the green color, and microwave oven 202 is associated with the yellow color.

Then, the state having the highest priority is stored associated with the first blinking rhythm (blinking twice), and the state having the second highest priority is stored associated with the second blinking rhythm (blinking once). For example, with regard to washing machine 201, a breakdown is associated with the first blinking rhythm as the state having highest priority. The completion of the cleaning operation is associated with the second blinking rhythm as the state having the second highest priority.

Specifically, the user registers the ID of a home appliance at home controller 100 via a touch panel 106 or button 104, and also registers the state of the relevant home appliance in the descending order of the priority level. CPU 110 associates the ID of a home appliance with a color of light in lighting up scheme table 101C in memory 101. CPU 110 stores a plurality of states related to a relevant home appliance in association with the input order, a first blinking rhythm and a second blinking rhythm in lighting up scheme table 101C in memory 101.

FIG. 9 shows a pictorial representation of a data structure of a home appliance table 101D according to the present embodiment. Referring to FIG. 9, home appliance table 101D stores the corresponding relationship between a home appliance ID for identifying home appliances 201-203 and a room ID for identifying the room where each of home appliances 201-203 is installed.

Returning to FIG. 4, display 102 shows the state of home appliances 201-203 under control by CPU 110. Tablet 103 detects a touch operation by the user's finger to apply the touch coordinates or the like to CPU 110. CPU 110 receives an instruction from the user via tablet 103.

In the present embodiment, tablet 103 is provided at the surface of display 102. More specifically, display 102 and tablet 103 constitute a touch panel 106 in the present embodiment.

Button 104 is arranged at the surface of home controller 100. A plurality of buttons such as the ten-key may be arranged at home controller 100. Button 104 serves to accept an instruction from the user. Button 104 applies an instruction from the user to CPU 110.

Communication interface 105 transmits and receives data, under control of CPU 110, to and from home appliances 201-203, LEDs 301-306, motion sensors 401-406 and brightness sensors 501-506, via network 200.

CPU 110 executes various programs stored in memory 101. The processing at home controller 100 is realized by each hardware and software executed by CPU 110. Such software may be prestored in memory 101. Alternatively, the software may be stored in a storage medium and distributed as a program product. Alternatively, the software may be presented as a program product that can be downloaded by an information provider connected on the Internet.

Such software is read out from the storage medium by utilizing a reader not shown, or downloaded by using communication interface 105 to be temporarily stored in memory 101. CPU 110 stores the software in the form of an executable program in memory 101, and then executes the relevant program.

The recording medium includes a medium that stores a program in a non-volatile manner such as a CD-ROM (Compact Disc-Read Only Memory), DVD-ROM (Digital Versatile Disk-Read Only Memory), USB (Universal Serial Bus) memory, memory card, FD (Flexible Disk), hard disk, magnetic tape, cassette tape, MO (Magnetic Optical Disc), MD (Mini Disc), IC (Integrated Circuit) card (excluding memory card), optical card, mask ROM, EPROM, and EEPROM (Electronically Erasable Programmable Read-Only Memory).

The program referred to herein includes, not only a program that can be directly executed by a CPU, but also a program in a source program form, a program subjected to compression, an encrypted program, and the like.

CPU 110 receives the state of relevant home appliances 201-203 from home appliances 201-203 via communication interface 105. For example, CPU 110 receives an error message from washing machine 201. CPU 110 refers to lighting up scheme table 101C to obtain the color corresponding to washing machine 201 and the blinking rhythm corresponding to the error.

CPU 110 refers to motion sensor table 101A based on the signals from motion sensors 401-406 to obtain a room ID of the room where a person is present. CPU 110 refers to illumination table 101B to identify LED 301 to which a lighting up instruction is to be transmitted based on the room ID. CPU 110 transmits a blue color blinking message to LED 301 via communication interface 105. At this stage, CPU 110 preferably stores the former lighting up state of LED 301 in memory 101.

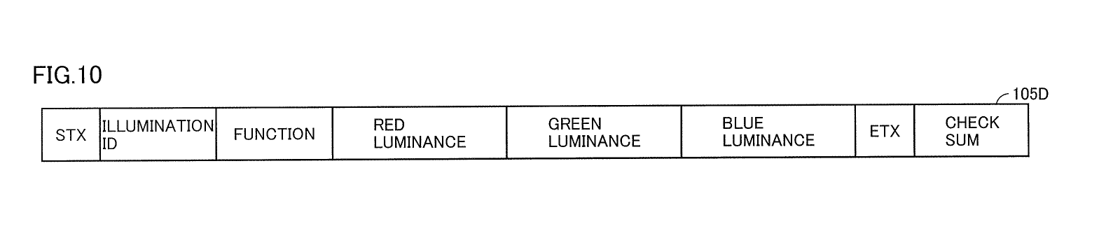

FIG. 10 shows a pictorial representation of a data structure of control data 105D transmitted to LEDs 301-306 by home controller 100 according to the present embodiment. Referring to FIG. 10, control data 105D includes STX data, illumination ID, function data, red color luminance, green color luminance, blue color luminance, ETX data, and check sum data.

STX data represents the start code. Illumination ID represents the ID number (00 to 99) of an LED illumination apparatus. The red color luminance represents the lightness (0-255) of the red color LED. The green color luminance represents the lightness (0-255) of the green color LED. The blue color luminance represents the lightness (0-255) of the blue color LED. ETF data represents an end code. The check sum data represents the code for error detection.

For example, when LEDs 301-306 are to emit white light, home controller 100 transmits to LEDs 301-306 red color luminance 255, green color luminance 255, and blue color luminance 255. When LEDs 301-306 are to emit blue light, home controller 100 transmits to LEDs 301-306 red color luminance 0, green color luminance 0, and blue color luminance 255. When LEDs 301-306 are to emit green light, home controller 100 transmits to LEDs 301-306 red color luminance 0, green color luminance 255, and blue color luminance 0. When LEDs 301-306 are to emit yellow light, home controller 100 transmits to LEDs 301-306 red color luminance 255, green color luminance 255 and blue color luminance 0.

In a case where LEDs 301-306 are capable of more lighting up schemes, control data 105D may include, as the function data, a lighting off instruction (00), an always-on instruction (01), a first notification instruction (10), and a second notification instruction (11).

LED 301 emits light of white and blue according to a series of blinking rhythm constituted of white for 10 seconds, blue for 1 second, white for 1 second, and blue for 1 second according to control data 105D sequentially sent from home controller 100. Accordingly, the user can recognize that an error has occurred at washing machine 201.

Then, CPU 110 receives a normal state message from washing machine 201 via communication interface 105. CPU 110 reads out the former lighting up state of LED 301 from memory 101. CPU 110 transmits to LED 301 a lighting up instruction indicating the former lighting up state (light off instruction) via communication interface 105.

<Overall Operation of Network System 1>

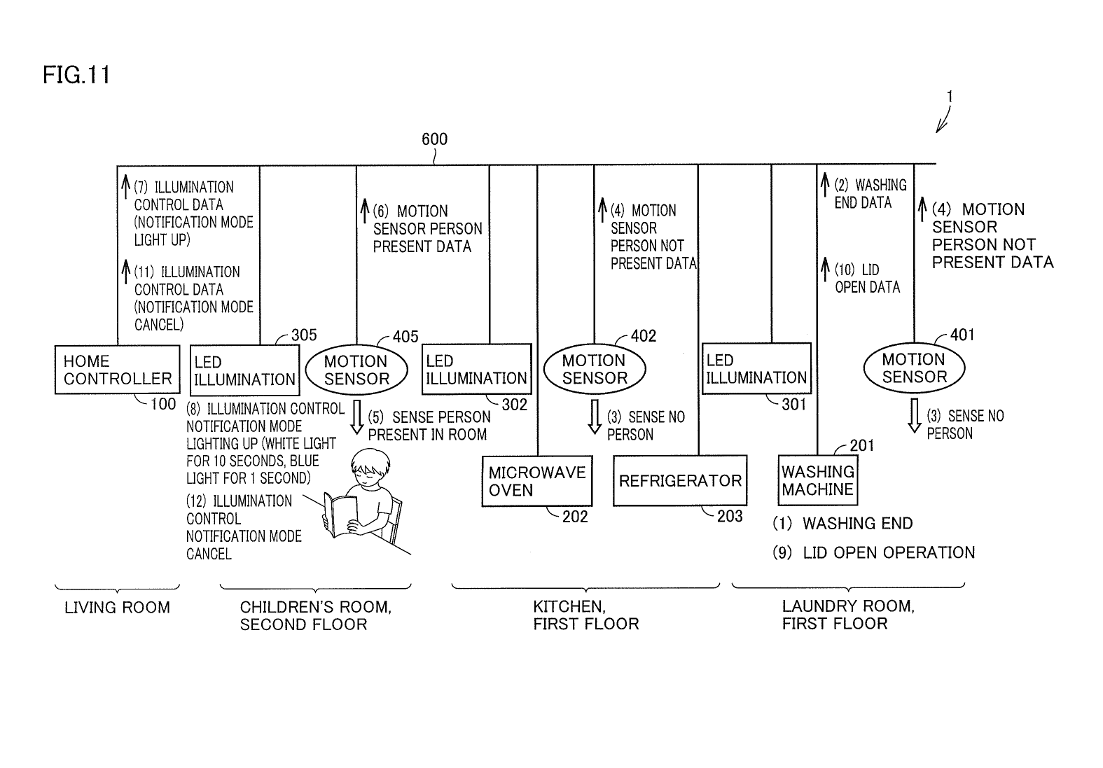

An overall operation of network system 1 according to the present embodiment will be described hereinafter. FIG. 11 shows a pictorial representation of an overall operation of network system 1 according to the present invention.

Referring to FIG. 11, the operation of each device in network system 1 and the data flow in network system 1 will be described in time series.

(1) Washing machine 201 ends the cleaning operation.

(2) Washing machine 201 transmits to home controller 100 data indicating that the cleaning operation has ended via network 600. The relevant data indicates the home appliance ID of washing machine 201 and the end state at washing machine 201. CPU 110 of home controller 100 receives the relevant data from washing machine 201 via communication interface 105. CPU 110 causes motion sensors 401-406 to detect whether a person is present in respective rooms via network 600.

(3) Motion sensors 401, 402, 403, 404 and 406 determine that a person is not present in the relevant room.

(4) Motion sensors 401, 402, 403, 404 and 406 transmit to home controller 100 a message indicating that a person is not present in the relevant room.

(5) Motion sensor 405 determines that a person is present in the relevant room.

(6) Motion sensor 405 transmits a message indicating that a person is present in the room to home controller 100.

(7) CPU 110 of home controller 100 refers to lighting up scheme table 101C in memory 101 to determine the lighting up scheme based on the data from washing machine 201. CPU 110 transmits control data 105D based on the relevant lighting up scheme to LED 305 corresponding to motion sensor 405 (LED 305 corresponding to the room ID of the room where motion sensor 405 is installed) via communication interface 105. CPU 110 stores the former lighting up state of LED 305 into memory 101.

(8) LED 305 emits light according to a series of blinking rhythm constituted of white for 10 seconds and blue for 1 second according to control data 105D from home controller 100. In the present embodiment, home controller 100 continues to transmit control data 105D that is more specific than the lighting up scheme until (11) based on the lighting up scheme. In the case where LED 305 includes a computer that can execute processing of a higher level, control data 105D may include a lighting up scheme.

(9) The lid of washing machine 201 is opened.

(10) Washing machine 201 transmits to home controller 100 data indicating that the lid has been opened via network 600. The relevant data indicates the home appliance ID of washing machine 201 and the opened state of washing machine 201. CPU 110 of home controller 100 receives the relevant data from washing machine 201 via communication interface 105.

(11) Based on the data from washing machine 201, CPU 110 of home controller 100 transmits, via communication interface 105, control data 105D according to the former lighting up scheme control data 105D to LED 305 that has transmitted control data 105D at (8).

(12) LED 305 emits white light according to control data 105D from home controller 100.

<Illumination Control Method>

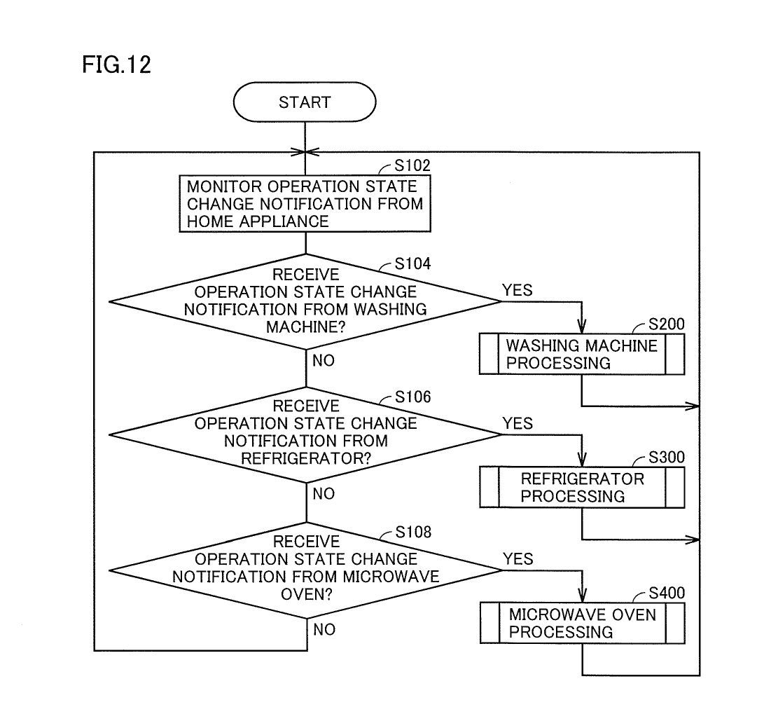

A method of controlling illumination by home controller 100 according to the present embodiment will be described hereinafter. FIG. 12 is a flowchart of the processing procedure of the illumination control method by home controller 100 according to the present embodiment.

Referring to FIG. 12, CPU 110 monitors an operation state change notification from home appliances 201-203 via communication interface 105 (step S102).

CPU 110 determines whether an operation state change notification is received from washing machine 201 via communication interface 105 (step S104). When an operation state change notification is received from washing machine 201 (YES at step S104), CPU 110 executes the washing machine processing (step S200). The washing machine processing (step S200) will be described afterwards. CPU 110 repeats the processing from step S102.

When an operation state change notification is not received from washing machine 201 (NO at step S104), CPU 110 determines whether an operation state change notification is received from refrigerator 203 via communication interface 105 (step S106). When an operation state change notification is received from refrigerator 203 (YES at step S106), CPU 110 executes the refrigerator processing (step S300). The refrigerator processing (step S300) will be described afterwards. CPU 110 repeats the processing from step S102.

When an operation state change notification is not received from refrigerator 203 (NO at step S106), CPU 110 determines whether an operation state change notification is received from microwave oven 202 via communication interface 105 (step S108). When an operation state change notification is received from microwave oven 202 (YES at step S108), CPU 110 executes the microwave oven processing (step S400). The microwave oven processing (step S400) will be described afterwards. CPU 110 repeats the processing from step S102.

When an operation state change notification is not received from microwave oven 202 (NO at step S108), CPU 110 repeats the processing from step S102.

<Washing Machine Processing>

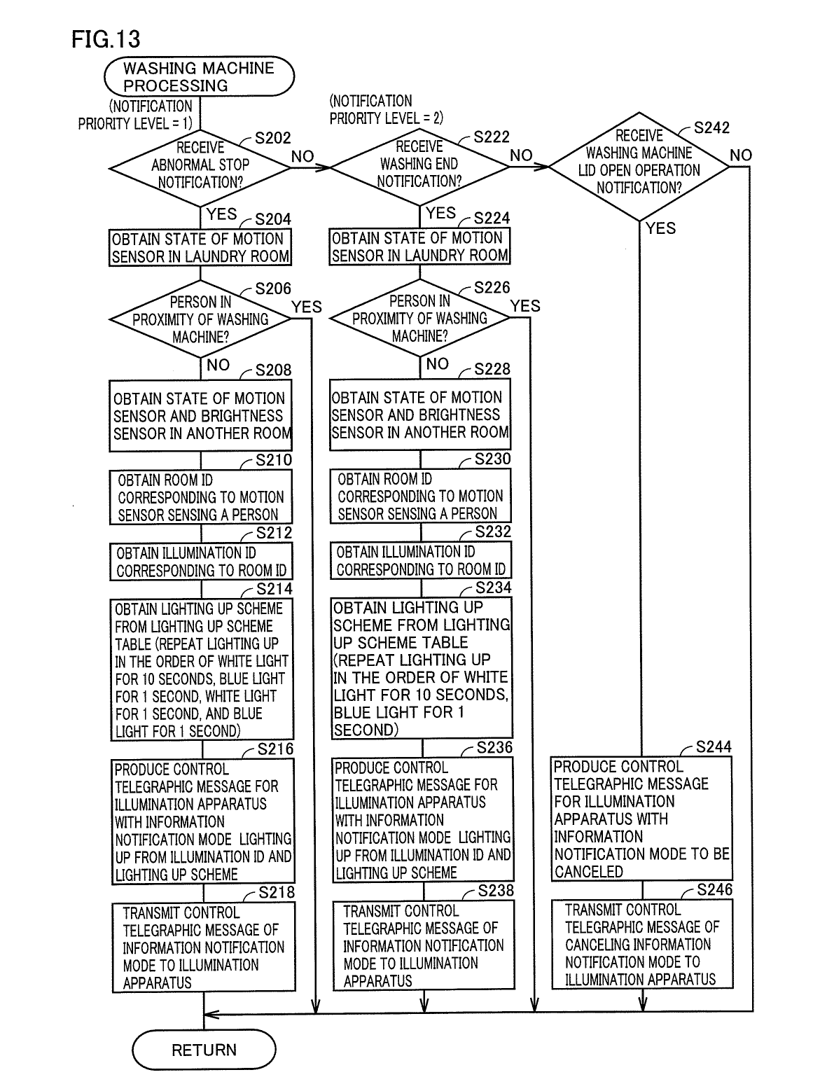

The washing machine processing at home controller 100 according to the present embodiment will be described hereinafter. FIG. 13 is a flowchart of the procedure of the washing machine processing at home controller 100 of the present embodiment.

Referring to FIG. 13, CPU 110 determines whether an abnormal stop notification is received from washing machine 201 via communication interface 105 (step S202). When an abnormal stop notification is received (YES at step S202), CPU 110 obtains the state of motion sensor 401 located in the laundry room (step S204). Specifically, CPU 110 receives data from motion sensor 401 via communication interface 105. Alternatively, CPU 110 reads out from memory 101 the data received in advance from motion sensor 401.

CPU 110 determines whether a person is present or not in the room where motion sensor 401 is installed based on the data from motion sensor 401. CPU 110 determines whether there is a person in the proximity of washing machine 201 (step S206). When a person is in the proximity of the washing machine (YES at step S206), CPU 110 ends the washing machine processing. This is because the possibility of a user becoming aware of an abnormal stop of the washing machine is high when the user is in the proximity of the washing machine.

When a person is not in the proximity of washing machine 201 (NO at step S206), CPU 110 obtains the state of a motion sensor and a brightness sensor located at another room (step S208). CPU 110 obtains the room ID corresponding to the motion sensor sensing a person (step S210). CPU 110 obtains the illumination ID corresponding to that room ID (step S212).

CPU 110 refers to lighting up scheme table 101C to obtain the lighting up scheme corresponding to the abnormal stop notification (step S214). More specifically, CPU 110 obtains the blue color corresponding to washing machine 201 and the blinking rhythm corresponding to the abnormal stop notification (a series of blinking rhythm constituted of white for 10 seconds, blue for 1 second, white for 1 second, blue for 1 second).

CPU 110 produces a control telegraphic message corresponding to the relevant illumination ID based on the illumination ID and lighting up scheme (step S216). CPU 110 transmits the control telegraphic message to the LED corresponding to the relevant illumination ID via communication interface 105 (step S218).

When an abnormal stop notification is not received (NO at step S202), CPU 110 determines whether a washing end notification is received from washing machine 201 via communication interface 105 (step S222). When a washing end notification is received (YES at step S222), CPU 110 obtains the state of the motion sensor located at the laundry room (step S224).

CPU 110 determines whether a person is in the proximity of washing machine 201 (step S226). When there is a person in the proximity of washing machine 201 (YES at step S226), CPU 110 ends the washing machine processing.

When a person is not in the proximity of washing machine 201 (NO at step S226), CPU 110 obtains the state of a motion sensor and a brightness sensor located at another room (step S228). CPU 110 obtains the room ID corresponding to the motion sensor that has sensed a person (step S230). CPU 110 obtains the illumination ID corresponding to the room ID (step S232).

CPU 110 obtains the lighting up scheme corresponding to washing machine 201 and washing machine end notification based on lighting up scheme table 101C (step S234). More specifically, CPU 110 obtains the blue color corresponding to washing machine 201 and a blinking rhythm corresponding to the washing end notification (a series of blinking rhythm constituted of white for 10 seconds, blue for 1 second).

CPU 110 produces a control telegraphic message based on the illumination ID and lighting up scheme (step S236). CPU 110 transmits via communication interface 105 the control telegraphic message to the LED corresponding to the illumination ID (step S238). CPU 110 ends the washing machine processing.

When a washing end notification is not received (NO at step S222), CPU 110 determines whether a lid open operation notification of washing machine 201 is received or not via communication interface 105 (step S242). When a lid open operation notification of washing machine 201 is not received (step S242), CPU 110 ends the washing machine processing.

When a lid open operation notification of washing machine 201 is received (YES at step S242), CPU 110 produces a control telegraphic message to return the LED that has transmitted the lighting up scheme to the former lighting up state (step S244). CPU 110 transmits the control telegraphic message to the relevant LED via communication interface 105 (step S246). CPU 110 ends the washing machine processing.

<Refrigerator Processing>

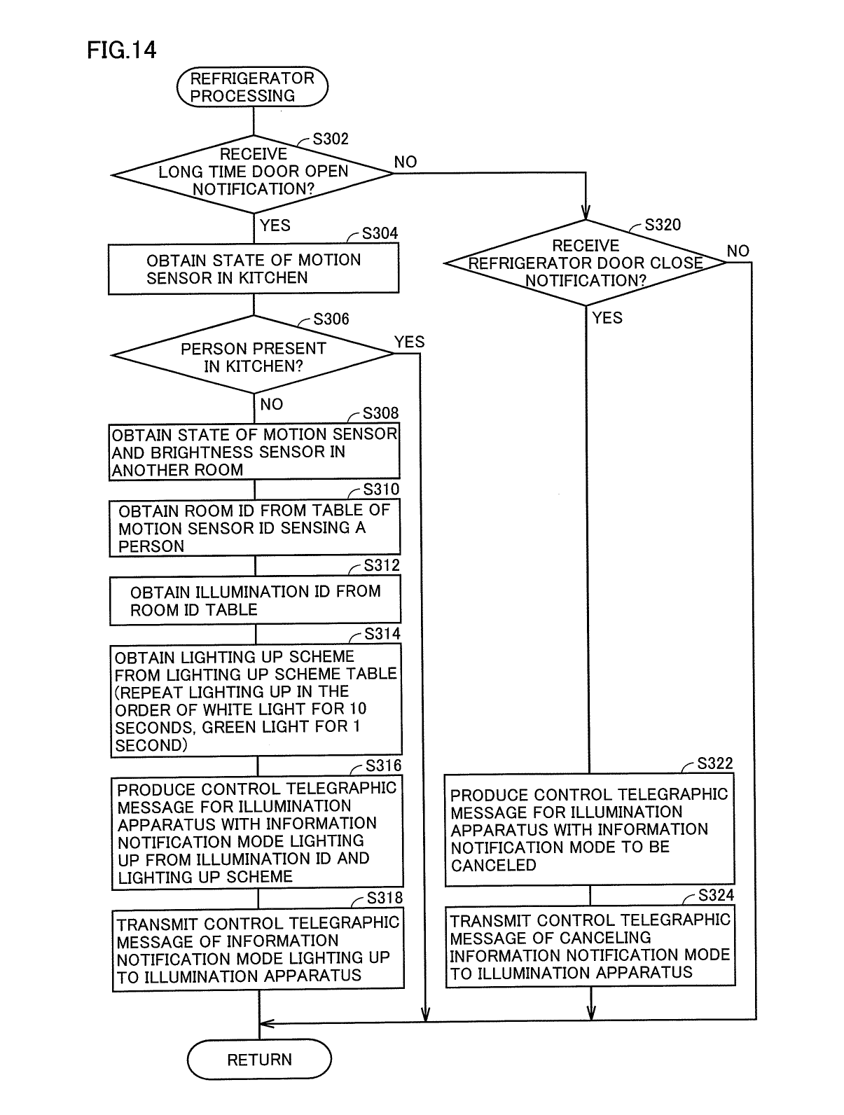

The refrigerator processing at home controller 100 of the present embodiment will be described hereinafter. FIG. 14 is a flowchart of the procedure of the refrigerator processing at home controller 100 according to the present embodiment.

Referring to FIG. 14, CPU 110 determines whether a message indicating that the door has been open for a long time is received from refrigerator 203 via communication interface 105 (step S302).

When the relevant message has been received (YES at step S302), CPU 110 obtains the state of motion sensor 402 located in the kitchen (step S304). In other words, CPU 110 determines whether a person is present in the kitchen (step S306). When a person is present in the kitchen (YES at step S306), CPU 110 ends the refrigerator processing.

When a person is not present in the kitchen (NO at step S306), CPU 110 obtains the state of a motion sensor and a brightness sensor located at another room (step S308). CPU 110 obtains the room ID corresponding to the motion sensor that has detected a person (step S310). CPU 110 obtains the illumination ID corresponding to the room ID table (step S312).

CPU 110 refers to lighting up scheme table 101C to obtain the lighting up scheme based on refrigerator 203 and the message (step S314). More specifically, CPU 110 obtains the green color corresponding to refrigerator 203, and a blinking rhythm corresponding to the message indicating that the door is open (a series of blinking rhythm constituted of white for 10 seconds, green for 1 second) (step S314).

CPU 110 produces a control telegraphic message based on the illumination ID and lighting up scheme (step S316). CPU 110 transmits the control telegraphic message to the LED corresponding to the illumination ID via communication interface 105 (step S318).

When the aforementioned message is not received (NO at step S302), CPU 110 determines whether a message indicating that the door of the refrigerator is closed is received via communication interface 105 (step S320). When the relevant message is not received (NO at step S320), CPU 110 ends the refrigerator processing.

When the relevant message is received (YES at step S320), CPU 110 produces a control telegraphic message to return the LED that has transmitted the lighting up scheme to the former lighting up scheme (step S322). CPU 110 transmits the control telegraphic message to the relevant LED via communication interface 105 (step S324). CPU 110 ends the refrigerator processing.

<Microwave Oven Processing>

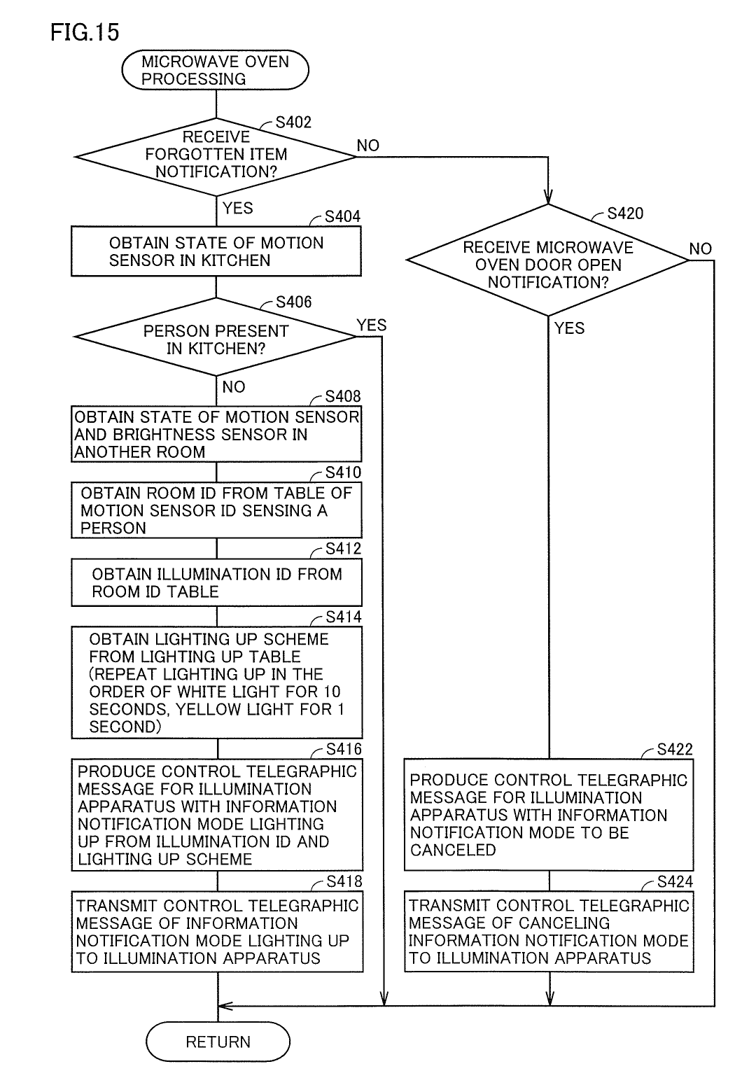

The microwave oven processing at home controller 100 according to the present embodiment will be described hereinafter. FIG. 15 is a flowchart of the procedure of the microwave oven processing at home controller 100 according to the present embodiment.

Referring to FIG. 15, CPU 110 determines whether a forgotten item notification is received from microwave oven 202 via communication interface 105 (step S402).

When a forgotten item notification is received (YES at step S402), CPU 110 obtains the state of motion sensor 402 located in the kitchen (step S404). CPU 110 determines whether a person is present in the kitchen (step S406). When a person is present in the kitchen (YES at step S406), CPU 110 ends the microwave oven processing.

When a person is not present in the kitchen (NO at step S406), CPU 110 obtains the state of a motion sensor and a brightness sensor located in another room (step S408). CPU 110 obtains the room ID corresponding to the motion sensor that has sensed a person (step S410). CPU 110 obtains the illumination ID based on the room ID (step S412).

CPU 110 refers to lighting up scheme table 101C to obtain the lighting up scheme based on microwave oven 202 and the forgotten item notification (step S414). More specifically, CPU 110 obtains the yellow color corresponding to microwave oven 202 and a blinking rhythm corresponding to the forgotten item notification (a series of blinking rhythm constituted of white for 10 seconds, yellow for 1 second) (step S414).

CPU 110 produces a control telegraphic message based on the illumination ID and lighting up scheme (step S416). CPU 110 transmits the relevant control telegraphic message to the LED corresponding to the illumination ID via communication interface 105 (step S418). CPU 110 ends the microwave oven processing.

When a forgotten item notification is not received (NO at step S402), CPU 110 determines whether a door open notification of microwave oven 202 is received or not via communication interface 105 (step S420). When a door open operation notification of the microwave oven is not received (NO at step S420), CPU 110 ends the microwave oven processing.

When a door open operation notification of microwave oven 202 is received (YES at step S420), CPU 110 produces a control telegraphic message to return the LED that has transmitted the lighting up scheme to the former lighting up scheme (step S422). CPU 110 transmits the relevant control telegraphic message to the relevant LED via communication interface 105 (step S424). CPU ends the microwave oven processing.

### Other Embodiments

The present invention is also applicable to the case achieved by supplying the program to a report display device and/or server. The advantage of the present invention can be offered by supplying to a system or device the storage medium storing the program represented by the software directed to achieving the present invention, and then reading out and executing the program codes stored in the storage medium by the computer (or CPU or MPU) of that system or device.

In this case, the program codes per se read out from the storage medium realize the function of the embodiment set forth above, and the storage medium storing the program codes constitutes the present invention.

In addition to realizing the functions of the embodiment set forth above by executing program codes read out by a computer, the function of the above-described embodiment may be realized by a process according to an OS (operating system) running on the computer performing a part of or all of the actual process, based on the commands of the program codes.

Furthermore, the program codes read out from the storage medium may be written to a memory included in a functionality expansion board inserted to a computer or a functionality expansion unit connected to a computer. Then, the function of the aforementioned embodiment may be realized by a process according to a CPU or the like provided on the functionality expansion board or the functionality expansion unit, performing a part of or all of the actual process, based on the commands of the program codes.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

1 network system; 100 home controller; 101 memory; 101 A motion sensor table; 101B illumination table; 101C lighting up scheme table; 101D home appliance table; 101E brightness sensor table; 102 display; 103 tablet; 104 button; 105 communication interface; 105D control data; 106 touch panel; 201 washing machine; 202 microwave oven; 203 refrigerator; 301-306 LED; 401-406 motion sensor; 501-506 brightness sensor; 600 network.

1. A controller comprising:
a communication interface for communicating with at least one illumination and a plurality of home appliances;
a memory for storing a corresponding relationship between said plurality of home appliances and a lighting up scheme of said illumination; and
a processor for obtaining, upon receiving a signal from one of said plurality of home appliances indicating a state thereof, a lighting up scheme corresponding to the home appliance on the basis of the corresponding relationship, using the communication interface, and for instructing at least one illumination to light up in accordance with the lighting up scheme.

2. The controller according to claim 1, wherein:
said illumination can emit light of a plurality of colors;
said memory stores said plurality of colors corresponding to said plurality of home appliances, respectively, as said lighting up scheme; and
said processor obtains, upon receiving a signal from one of said plurality of home appliances, a color corresponding to the home appliance, as said lighting up scheme, using the communication interface, and instructs at least one of said illumination to emit light of the color.

3. The controller according to claim 1, wherein:
said memory stores a corresponding relationship between a state of said home appliance and a blinking rhythm of said illumination;
said signal indicates a state of said home appliance; and
said processor obtains, upon receiving said signal, a blinking rhythm corresponding to the state on the basis of said corresponding relationship, using the communication interface, and instructs at least one of said illumination to emit light in accordance with said blinking rhythm.

4. The controller according to claim 3, wherein
said memory stores said state associated with a priority level for every said home appliance; and
said processor obtains, when said processor receives a plurality of said states using the communication interface, said blinking rhythm corresponding to said state having a higher priority level, and instructs at least one of said illumination to emit light in accordance with said blinking rhythm.

5. The controller according to claim 1, wherein:
said communication interface establishes communication with a motion sensor installed in a room where said illumination is installed,
said memory stores a corresponding relationship between said motion sensor and said illumination; and
said processor instructs said illumination installed in a room where a person is present to emit light on the basis of the signal received from said motion sensor, using said communication interface.

6. The controller according to claim 1, wherein:
said communication interface establishes communication with a brightness sensor installed in a room where said illumination is installed; and
said processor instructs emission of light at an intensity corresponding to lightness in said room on the basis of the signal from said brightness sensor, using said communication interface.

7. The controller according to claim 1, wherein said illumination includes an LED (Light Emitting Diode).

8. A method for controlling illumination by a controller including a communication interface for communication with at least one illumination that can emit light of a plurality of colors and a plurality of home appliances, a memory for storing a corresponding relationship between said plurality of home appliances and a lighting up scheme of said illumination, and a processor, said method of controlling illumination comprising the steps of:
receiving, by said processor, a signal indicating a state of said home appliance from any of said plurality of home appliances, using said communication interface;
obtaining, by said processor, a lighting up scheme corresponding to the home appliance on the basis of said corresponding relationship, referring to said memory; and
instructing, by said processor, at least one of said illumination to light up in accordance with said relevant lighting up scheme, using said communication interface.

9. A network system including at least one illumination that can emit light of a plurality of colors, a plurality of home appliances, and a controller, wherein each of said plurality of home appliances transmits a signal indicating a state of the home appliance to said controller,
said controller includes:
a communication interface for communicating with at least one illumination and a plurality of home appliances;
a memory for storing a corresponding relationship between said plurality of home appliances and a lighting up scheme of said illumination; and
a processor for obtaining, upon receiving a signal from one of said plurality of home appliances indicating the state thereof, a lighting up scheme corresponding to the home appliance on the basis of the corresponding relationship, using the communication interface, and for instructing at least one illumination to light up in accordance with the lighting up scheme, and
said at least one illumination emits light according to an instruction from said controller.
